(19) United States
(12) Patent Application Publication
(10) Pub. No.: US 2002/0193986 A1
(43) Pub. Date: Dec. 19, 2002

(54) Pre-translated multi-lingual email system, method, and computer program product

(76) Inventor: Alphonsus Albertus Schirris, Heerhugowaard (NL)

Correspondence Address: VENABLE, BAETJER, HOWARD AND CIVILETTI, LLP, P.O. BOX 34385, WASHINGTON, DC, 20043-9998, US

(21) Appl. No.: 10/211,303

(22) Filed: Aug. 5, 2002

Related U.S. Application Data
(63) Continuation-in-part of application No. 09/698,184, filed on Oct. 30, 2000.

(51) Int. Cl. G06F 17/20

(52) U.S. Cl. 704/8

(57) ABSTRACT

A system, method and computer program product for generating a multi-lingual email message including generating a unique identifier (UID) code for a term; translating the term into a plurality of languages giving rise to a plurality of pre-translated terms to the UID; associating the term and the plurality of translated terms with the UID; and storing the term, the plurality of translated terms, and the UID, in a UID database. In another embodiment, a system, method and computer program product are provided for reviewing the multi-lingual email message including receiving the multilingual email message from a sender; parsing the multi-lingual query into a plurality of UID associated terms; determining a UID code corresponding to each term within the message querying a database using the UIDs and displaying the translated term corresponding to the UID, resulting in a translated message in a language selected by the resipient of the message.

### BACKGROUND OF THE INVENTION

1. Field of the Invention

The present invention relates to the field of computerized information electronic mail (email) systems. More particularly, this invention relates to a method and apparatus for sending and receiving emails in multiple languages.

2. Related Art

With the advent of the global Internet, vast databases of content have become accessible online and worldwide. With decreasing costs of electronic storage, printed materials that formerly would have occupied tremendous space can now be stored in much less space. Electronic databases on online servers can now be searched from client computers in locations around the world. Similarly, information stored in databases from all over the world is also widely available.

As a result of this worldwide activity, vast computerized databases of documents have been developed. However, many documents that exist in these collections appear in languages that the user of the database is not familiar with. This makes the retrieval of many relevant documents cumbersome if not impossible using conventional computer search techniques. This is because conventional search techniques rely on the ability of a user to create a query that is useful in the database. Since users may not be familiar with the language of particular databases, those databases are not accessible to such users by conventional techniques. As a result, substantial efforts have been directed to developing procedures by which search queries crafted in one language could be used to retrieve relevant documents existing in another language.

Conventional techniques for retrieving foreign language documents can use a translator or a machine translation system to translate the user's query. An example of a machine translation system can be found in U.S. Pat. No. 5,136,504 to Fushimoto, for a “Machine translation system for output of kana/kanji characters corresponding to input character keys,” the contents of which is incorporated herein by reference in its entirety. Another example can be found in U.S. Pat. No. 5,020,021 to Kaji, for a “System for automatic language translation using several dictionary storage areas and a noun table,” the contents of which is incorporated herein by reference in its entirety. A disadvantage of machine translation systems is that they can be difficult to create and, even when they operate properly, they can make mistakes. As a result, they can be difficult to use.

It is desirable that queries including search terms in multiple languages be supported. For example, in multi-lingual countries such as, e.g., Canada, Belgium, South Africa, and Switzerland, use of multi-lingual search terms would be very useful. Conventional systems require that the user translate terms and then place the translated terms into a query. This can be an arduous process, particularly for users who frequently communicate in multiple languages. Conventional portals such as, e.g., Yahoo!, provide for searching by country, by which a user can select a country and then place a search in a native tongue, such as, e.g., German. Unfortunately, suppose a search for “garden center” (i.e., “garden center” in German) is entered into the search tool; results are only in German. Unfortunately, suppose, e.g., that you lived in Switzerland, where French, German, and Italian are spoken. Even if a user spoke all three languages, to find search results in the three languages, then at least three separate searches would be needed to obtain information relevant to the search terms. The problems associated with these retrieval methods highlight the need for the user to be able to retrieve relevant foreign documents by querying a search tool with search terms in multiple languages, without knowledge on the part of the user of the translated search term.

It is desirable that improved systems, methods and computer program products be provided that overcome the shortcomings of conventional search engines.

In addition it is desirable that a database be provided which stores translated terms that can be accessed in the process of creating or reading a multilingual email message such that desired terms display in a desired language.

### SUMMARY OF THE INVENTION

The present invention is directed to systems, methods, and computer program products for generating a multilingual database including generating a unique identifier (UID) code for a term; translating the term into a plurality of languages yielding a plurality of translated terms corresponding to the term; associating the term and the plurality of translated terms with the UID; and storing the term, the plurality of translated terms, and the UID, in a UID database.

In an exemplary embodiment, the UID can include a world wide language (WWL) word; a UPC barcode symbol; an alphanumeric identifier; a binary number; or a hexadecimal number.

In an exemplary embodiment, the term can include a word; a phrase; a plurality of words; an expression; literature; or documentation. Other examples of terms include, e.g., an article, an adjective, an adverb, a noun, a verb, a pronoun, a preposition, and any other grammatical term.

In an exemplary embodiment, the method can further include associating a plurality of data records with said UID code. In an exemplary embodiment, each of the plurality of data records can include a name of a business; a name of a person; an email address; a universal resource locator (URL) corresponding to a document; a brief description of said document; a title of said document; a mailing address; a phone number; a language; a geographic region; a country; a company name; an area code or other telephone region indicator; a zip code or other postal region indicator; a contact name; and an administrative password.

In an exemplary embodiment, the plurality of languages can include, e.g., Chinese; English; Spanish; French; German; Portuguese; Dutch; Japanese; Farsi; Turkish; Greek; Swedish; Danish; Swahili; Italian, and other languages.

In an exemplary embodiment, a global yellow pages directory database is enabled, where the term can include at least one of a business type, a service type, and a product type.

The present invention can also be directed to a system, method and computer program product for generating a multilingual email including, e.g., receiving one or more term selections from a sending user (sender) such as, e.g., an enduser, a computer, or a search engine); optionally, the sending user can select the term selections from a list of terms from multiple languages, determining a unique identifier (UID) code corresponding to each selected term of the term selections by accessing a UID database; storing the UID codes corresponding to the term selections upon a send indication from the sending user, resulting in an email message being sent to a receiving user. The invention can further include providing access to the email message including a stored combination of pre-associated UIDs; providing the email message to the receiving user (recipient); and optionally allowing the receiving user to select a language in which the generated multilingual email is to be displayed.

Advantageously, in an exemplary embodiment, a communication can be provided to receiving users that can each review the communication in the receiving users' native language.

In an exemplary embodiment, the UID database can be used as a multi-language dictionary.

Advantageously, UIDs can facilitate a world wide language (WWL). The WWL, in an exemplary embodiment, can not be intended to be written or spoken, but can instead be used to allow all people, communicating in a plurality of languages, to obtain potentially all documents related to a given subject, assuming the UID lexicon database is populated with all the languages of world and the document link/UID database is populated with all documents related to a given term corresponding to a UID.

Advantageously, according to an exemplary embodiment of the present invention, a multi-lingual dictionary service can be provided, using the UID lexicon database.

Advantageously according to an exemplary embodiment of the present invention, since all terms have been pre-translated into corresponding UIDs, a search query or other query to the UID database such as from a search engine query, or other application prepared by a client user can include terms written in any language pre-translated and associated with the UID in the UID lexicon database.

Advantageously, according to an exemplary embodiment of the present invention, a multi-lingual worldwide directory of businesses by specific term categories with rich detail can be provided by the combination of the UID lexicon database and the document link/UID database.

Advantageously, according to an exemplary embodiment of the present invention, a multi-lingual worldwide directory of persons organized by specific term categories with rich detail can be provided similarly by the combination of the UID lexicon database and the document link/UID database.

Advantageously, according to an exemplary embodiment of the present invention, loyalty shares can be provided by a given business to incent stakeholders such as, e.g., associate businesses, customers, and persons, to drive revenue (i.e., also referred to as “turn over”) through the given business.

Further features and advantages of the invention, as well as the structure and operation of various embodiments of the invention, are described in detail below with reference to the accompanying drawings. In the drawings, like reference numbers generally indicate identical, functionally similar, and/or structurally similar elements. The drawing in which an element first appears is indicated by the leftmost digits in the corresponding reference number.

### BRIEF DESCRIPTION OF THE DRAWINGS

The foregoing and other features and advantages of the invention will be apparent from the following, more particular description of exemplary embodiments of the invention, as illustrated in the accompanying drawings. A preferred embodiment is included below in the detailed description of the following drawings:

FIG. 1 depicts an exemplary embodiment of a high level system block diagram according to the present invention;

FIG. 2A depicts an exemplary embodiment of a database data structure according to the present invention;

FIG. 2B depicts an exemplary embodiment of an exemplary UID and linked multilingual terms according to the present invention;

FIG. 2C depicts an exemplary embodiment of a document link/UID database according to the present invention;

FIG. 3 depicts an exemplary embodiment of a query input field and search results output field according to the present invention;

FIG. 4 depicts an exemplary embodiment of a computer as can be used for several devices in the present invention;

FIG. 5 depicts an exemplary embodiment of a user interface of a multilingual email authoring application program screen capture wherein the sender of a multilingual email can select a desired display language;

FIG. 6 depicts an exemplary embodiment of a graphical user interface of the multilingual email authoring application by which the sender of the multilingual email can generate the multilingual email message to be sent to a recipient;

FIG. 7 depicts an exemplary embodiment of a user interface of the message displayed to the sender of the multilingual email message comprising a hyperlink to an interactive webpage in which the multi-lingual email message can be viewed;

FIG. 8 depicts an exemplary embodiment of an email client application program displaying an exemplary email message to the recipient of the generated multilingual email including a hyperlink which can direct the recipient to an interactive webpage from which the generated multilingual email message can be viewed; and

FIG. 9 depicts an exemplary embodiment of a graphical user interface of a multilingual email display viewer application displaying the generated multi-lingual email in a selected language (German).

### DETAILED DESCRIPTION OF AN EXEMPLARY EMBODIMENT OF THE PRESENT INVENTION

A preferred embodiment of the invention is discussed in detail below. While specific implementations are discussed, it should be understood that this is done for illustration purposes only. A person skilled in the relevant art can recognize that other components and configurations may be used without parting from the spirit and scope of the invention.

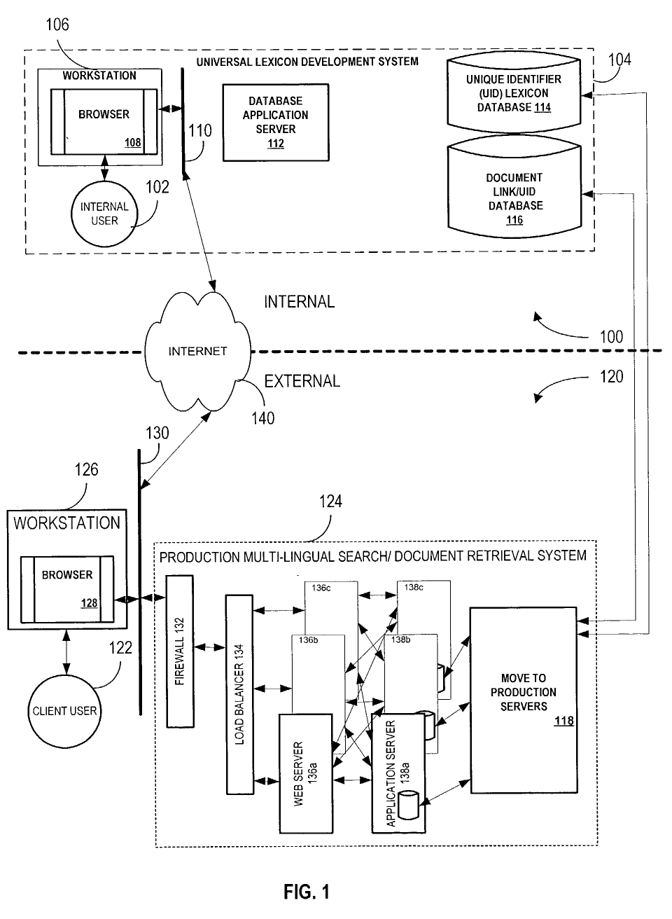

FIG. 1 depicts an exemplary embodiment of a high level system block diagram according to the present invention including an internal development system block diagram 100 and an external production system block diagram 120.

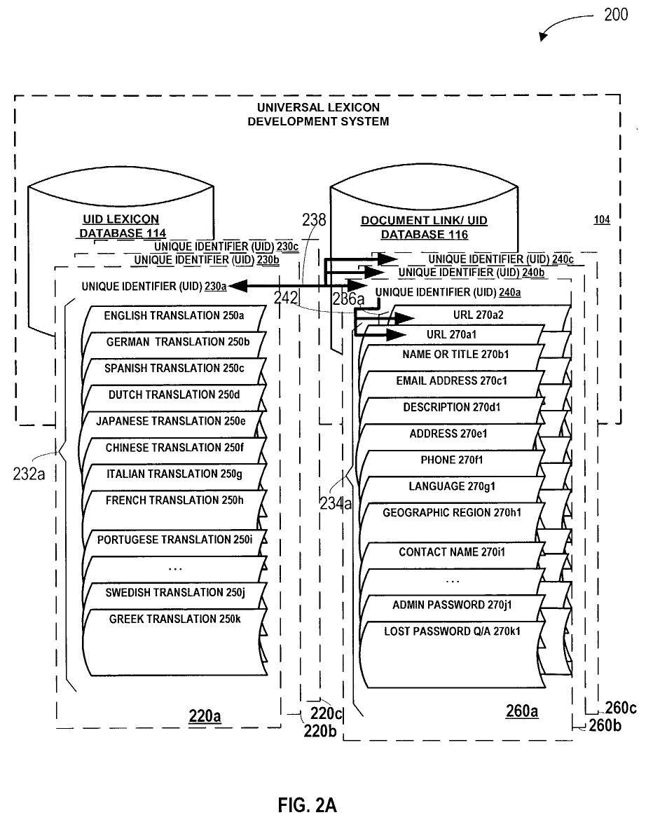

Internal development system block diagram 100 can comprise, in an exemplary embodiment, an internal user 102 interacting with a browser 108 of a workstation 106, as part of a universal lexicon development system 104. Workstation 106 can be coupled via a network 110 to a database management system application server 112. Database management system application server 112 can manage one or databases 114, 116. In an exemplary embodiment, the database management system application server 112 can manage a unique identifier (UID) lexicon database 114; and a document link/UID database 116. It will be apparent to those skilled in the art, that databases 114, 116 could be part of a single larger database, or could be broken into a plurality of separate subdatabases. The database development and processing performed by the internal users 102 can include organizing and populating databases 114, 116. See FIG. 2A, below, to review a more detailed exemplary embodiment of a database structure including records and fields.

External production system block diagram 120 can comprise, in an exemplary embodiment, a client user 122 interacting with a browser 128 on a workstation 126. The workstation 126 can be coupled via a network 130 and/or the global Internet 140, and a production search/document retrieval system 124 including, e.g., a firewall 132 coupled to a load balancer 134 (which could alternatively run on a general purpose computer such as, e.g., web server 136a). Load balancer 134 can be coupled to a web server 136a, 136b, and 136c. Web servers 136a-c can be mesh coupled to one or more application servers 138a, 138b, and 138c, each of which can include one or more production databases that can correspond to databases 114, 116. Web servers 136a-c, in an exemplary embodiment, can perform load balancing functions by transferring client user requests to one or more of the application servers 138a-138c according to semantics. The databases 114, 116 of application servers 138a-138c can be updated periodically by a process step 118 which can include transmitting and/or synchronizing from databases 114, 116 to databases (i.e., not labeled) of application servers 138a-138c.

FIG. 2A depicts an exemplary embodiment of a block diagram 200 illustrating database data structures according to the present invention. FIG. 2A, includes a more detailed exemplary embodiment of databases 114, 116. Block diagram 200 can include the universal lexicon development system 104 including the UID lexicon database 114 structure including records and fields, and the document link/UID database 116.

UID database 114 can include a plurality of unique identifiers (UIDs) 230a, 230b, and 230c which can be a numeric number, a binary number, a hexadecimal number, and an alphanumeric number, associated with a plurality of language translations. Exemplary language translations can include, e.g., an English translation 250a; a German translation 250b; a Spanish translation 250c; a Dutch translation 250d; a Japanese translation 250e; a Chinese translation 250f; an Italian translation 250g; a French translation 250h; a Portuguese translation 250i; a Swedish translation 250j; and a Geek translation 250k. By pre-translating the desired term into a plurality of translations 250a-250k, or collectively 250 or 232a, performance of the multi-language search engine facilitated by the present invention, is improved. Translations 232a in combination with UID 230a can be collectively referred to as a UID record 220a having translation fields 250a-250k.

Diagram 200 can also include a plurality of documents and/or links associated with (i.e., as indicated by arrow 242) a UID 240a, corresponding to UID 230a. In one exemplary embodiment, databases 114 and 116 can be combined into one large database, where UID 230a can be set equal to UID 240a. A given UID 240a can include a plurality of UID document/link records 234a, 236a, as shown. For example, document records 234a, 236a can include, e.g., URL 270a1, 270a2; name or title 270b1, 270b2 which could correspond, e.g., to a company, product or person; email address 270c1, 270c2 of, e.g., the company, product, or service; description 270d1, 270d2, which could be short or long; an address 270e1, 270e2; phone number 270f1, 270f2; language 270g1, 270g2, which could provide a language associated with, e.g., the document, website, company, or person; a geographic region 270h1, 270h2, such as, e.g., country, state, county, city and other region; contact name 270i1, 270, which can correspond to, e.g., a person who provided information, and a customer service person for a business; an administrative password 270j1, 270j2 securing access to changing record 234a; and lost password question and answer 270k1, 270k2 enabling a reminder of a user password. A plurality of UIDs 240a, 240b, and 240c can be grouped together such as, e.g., in a case of synonyms, and can be associated as illustrated with arrows 238.

FIG. 2B depicts an exemplary embodiment of a block diagram 280. Block diagram 280 can include an exemplary UID 230a of a UID Lexicon database 114 with a UID record 280a, in this case a binary number, and linked multilingual translated terms 250a1-250k1, according to the present invention. Each multi-lingual translated term 250a1-250k1 is shown associated with a record 290a-290k including a translated term. As an illustration, an English translation term 250a1 of garden center 290a is associated with UID 230a. Use of a search term “garden center” would automatically request a search based on the UID 230a record 280a, which includes all multi-lingual translation terms 250a1-250k1.

FIG. 2C depicts an exemplary embodiment of a block diagram 292 illustrating an exemplary document link/UID database 116 and data structure. Block diagram 292 includes an exemplary embodiment of an exemplary UID 240a (associated with UID 230a) with a UID record 280b, in this case a binary number, linked to a plurality of document/link multilingual documents/link results (only a single result record is shown). The result record shown includes result fields 270a1-270k1 with corresponding data fields 290a-290k, according to the present invention. As an illustration, suppose a search term of “software company” results in a result record corresponding to the homepage of the company MICROSOFT. Various fields 270a1-270k1, and 290a-290k are shown populated with exemplary data categorizing the result record. As will be understood to those skilled in the art, multi-lingual directories of companies, URLs, or E-mail addresses can be enabled using the exemplary data structure shown.

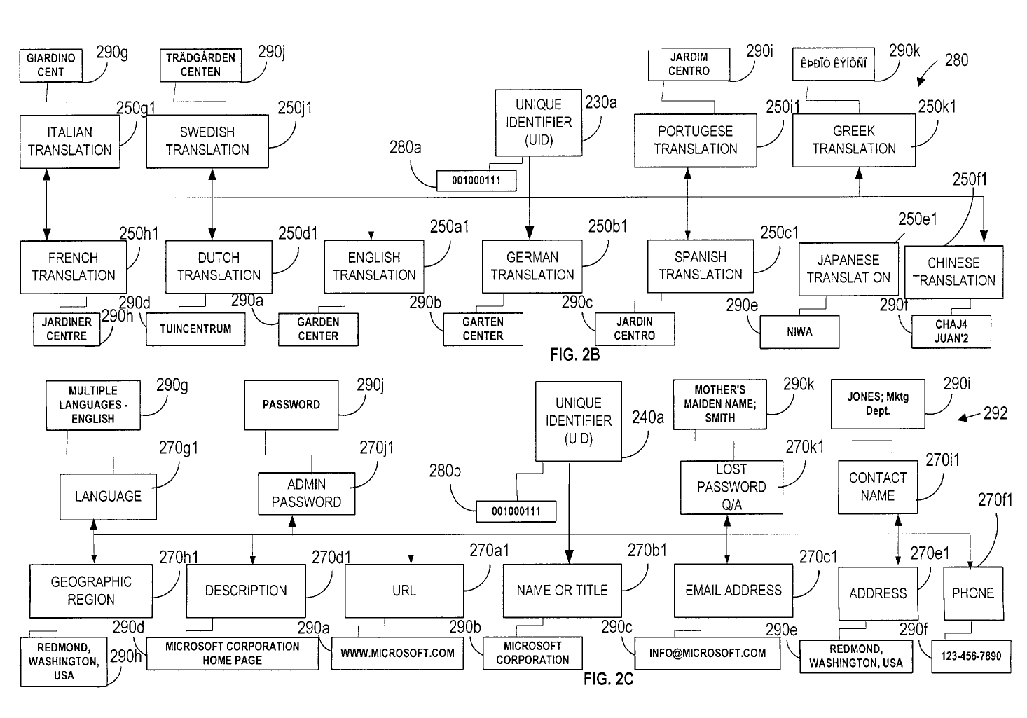

FIG. 3 depicts an exemplary embodiment of a graphical user interface 300 illustrating a query input field 302 including an exemplary search query 306. Upon entry of search query 306 and selection of search button 304, or depression of the <ENTER>key on the keyboard, search results 308 can be outputted to the browser 128 of client user 122. Results 308, as shown can include various search results documents/links 322, 324, 326, and 328.

Search query 306 can be interpreted according search query formatting semantic rules, which can be explained in documentation accessible via a help button. As shown, the search query 306 includes a search term 310 “Garten Center,” i.e., a German search query. In the exemplary embodiment, a delimiter 312, in this case, a comma, is used to separate a search term from search narrowing designations 314, 318, 320. Namely, search query 306 includes a designation requesting documents or links meeting the search term, and also meeting the geographic region limitation of USA 314, UK 318, or NL 320. Boolean operators 316 can be used to implement Boolean logic in narrowing search results. Other conventional methods of limiting search query results can be employed, such as, e.g., selection of a mouse selectable checkbox 330, in the exemplary embodiment, requesting search results/documents organized in alphabetical order.

Specifically, an exemplary embodiment of a technique to perform a query using a combination of the useful, novel and nonobvious processes of the present invention and useful conventional techniques is now described. A search query 306 can be entered in a form useful for processing in the computer. A conventional way to generate a search query involves a client user 122 manually typing in a search query using a keyboard 418 in one or more languages familiar to the client user 122. Advantageously, the present invention supports multi-lingual search terms. Also, by the use of pre-translated UIDs, search results in multiple languages are supported. Advantageously, according to the present invention, search results can be narrowed by, e.g., geographic region, language, and any of various other document link field attributes. Another method suitable for generating a search query 306 can include selection of text from another application program or document (e.g., using a graphical user interface and a mouse 416). After selection of text, a function key combination such as, e.g, <CONTROL-C> can be used to copy and <CONTROL-V> to paste the results into search entry field 302.

A search query once generated can be parsed into search terms. Alternatively, other means of breaking a search query into terms can be used including, e.g., use of a delimiter 312 such as, e.g., a comma, or quotation marks surrounding a term. Parsing can involve as little processing as breaking a search query 306 into individual words. Other conventional parsing can use a a more complex process in which the query is parsed into noun phrases, accomplished by a variety of techniques known in the art such as, e.g., the use of lexicons, morphological analyzers or natural language grammar structures. Conventional techniques can be used to parse a search query into noun phrases, verbs, numerical quantities, URLs, phone numbers, zip codes, and so on.

After the query has been parsed, corresponding UIDs can be determined for the constituent terms. It is possible that synonym UIDs can be associated with one another to produce additional search results.

The search engine can then analyze the document link/UID database 116 for results associated with a UID. In an exemplary embodiment, subqueries to various databases 114, 116 can be performed and results can be integrated into search results 308 ready for display. Analysis can include a conventional Boolean keyword search.

Once the documents and links are identified, the documents/links can be provided to the user in the user-requested format (e.g., alphabetical order) as search results 308. The language of the document or link can be displayed in the search results, as shown, if available. Other relevant data about the document or link available in fields of the document link/UID database, associated with the document if available can also be displayed.

Attempts have been made to overcome the shortcomings of conventional techniques. For example, the reader is directed to U.S. Pat. No. 6,055,528 to Evans (hereafter “Evans”) for a “Method for cross-linguistic document retrieval,” the contents of which is incorporated herein by reference in its entirety. Evans is directed to a method and apparatus for retrieving documents that are stored in a language other than the language that is used to formulate a search query. Evans decomposes the query into terms and then translates each of the terms into terms of the language of the database. In Evans, once the database language terms have been listed, a series of subqueries is formed by creating all the possible combinations of the listed terms. Each subquery is then scored on each of the documents in the target language database. Only those subqueries that return meaningful scores are relevant to the query. Thus, the semantic meaning of the query is determined against the database itself and those documents in the database language that are most relevant to that semantic meaning are returned. Evans appears to require translating each of the terms of a search query at the time of a query which can unfortunately be time consuming. Also, unfortunately, Evans appears to only support translation from only one language to another. Evans does not appear to address providing for a multi-lingual term capable search query in accordance with the present invention. Evans also does not appear to provide the robust document link field categorization provided by document link fields 234a according to the present invention.

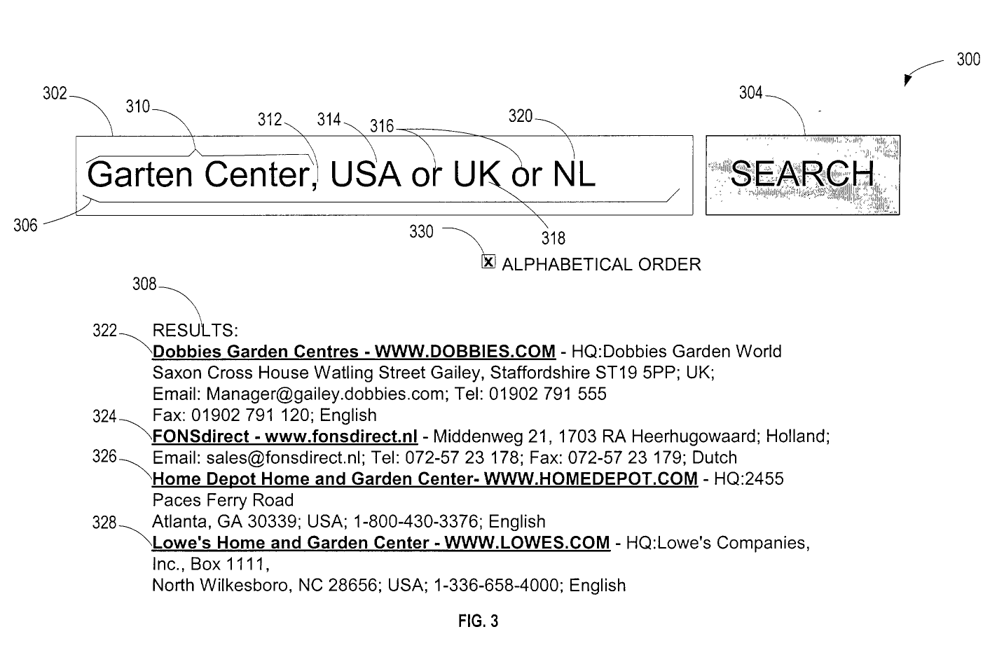

FIG. 4 depicts an exemplary embodiment of a computer 112, 126, 136, and 138 as can be used for several devices in the present invention. FIG. 4 is a block diagram of a computer system that can be used for retrieving information using, e.g., a web browser to retrieve documents from a database or web server, for managing a database as a database server, or for managing web access as a web server or application server. We will now describe the computer system in the context of a workstation 126 retrieving information from a server. Computer 126, in an exemplary embodiment, can comprise a central processing unit (CPU) or processor 404 and main memory 406. Computer 126 can be coupled to an Input/Output (I/O) system such as, e.g., a network interface card (NIC) 422, or a modem 424 for access to a network 130. Computer 126 can also be coupled to a secondary memory 408, such as a disk storage unit 410. The I/O system can also include a display 420, a keyboard 418 and a mouse or other pointing and selection device 416. In general, the disk storage unit 410 can store an application program for operating the computer system referred to commonly as an operating system, such as, e.g., Windows 2000. The disk storage unit 410 can also store documents of a database. Exemplary disk storage units 410 can include, e.g, a magnetic storage device such as, e.g., a hard disk, an optical storage device such as, e.g., a write once read many (WORM) drive, or a compact disc (CD), or a magneto optical device. Another type of secondary memory 408 can include a removable disk storage device 412 which can be used in conjunction with a removable storage media 414. The computer 126 can interact with the I/O system and the disk storage unit 410.

The computer 126 can execute a search application program that can be retrieved from the disk storage unit 50 on computer 126, or another computer system such as, e.g., application server 138. In an exemplary embodiment, the search application program can be written in a Java programming language and can be implemented as a web browser enabled application or applet. The search program can include a series of instructions that can cause the computer 126 via, e.g., a browser 128, to retrieve documents, or parts thereof, which can be stored in one or more databases coupled to a server computer system such as, e.g., application server 138. The search program 300 can advantageously provide a results 308 list of documents meeting the criteria in a corresponding search query 306, entered by the client user 122 into the search program 300. In an exemplary embodiment, rules or semantics can be implemented to narrow a list of results to a results 308 list that is most relevant to the query 306. The query 306 can be created and sent to the computer 126 in a variety of ways. For example, the query can be typed into a keyboard 418 or selected from a predefined list by operating the mouse 416 and, e.g., selecting an onscreen button such as a menu item such as checkbox 330, or search button 304. A search can alternatively be entered in another device, such as, e.g., a wireless device, or another application program and can be transferred to the computer 126. Also, the search program can generate a query automatically, by, e.g., taking a user through a software agent or so-called “wizard.”

The computer 126 can respond to the query 306 by retrieving a results 308 list of documents from the databases in the disk storage units 410 of application server 138. The computer 126 can process the query 306, in accordance with an exemplary embodiment of the present invention, to parse the search query 306 into one or more search terms 310, which can then be analyzed by, e.g., application server 138a, to determine a corresponding UID 230 by querying the UID lexicon database 114.

Advantageously, since all terms have been pre-translated into corresponding UIDs 230a-c, search query 306 can include search terms written in any language including, e.g., translations of languages 250a-250k. The search terms are already associated with a UID 230a. The computer 126 can then determine a list of documents 260a such as, e.g., URL 270a1-URL 270a2 by querying UID 240a, which corresponds to UID 230a as indicated by arrow 238, in the document link/UID database 116. UID 230a can also, in an exemplary embodiment, be associated with other UIDs 240b, 240c, such as, e.g., where UIDs 240b, 240c could be synonyms to UID 240a. As illustrated by arrows 242, UID 240a can be associated with a plurality of documents, links, people, e-mail addresses, companies, etc. For example, UID 240a can be preassociated with, e.g., two separate documents 270a1-k1, and 270a2-k2. The first document corresponding to universal resource locator (URL) 270a1 can have various other database fields associated with the document record 234a.

During the analysis process the computer 126 can interact with the disk storage unit 410 to, e.g., create one or more subqueries, and/or to aggregate results. The UIDs 230, 240 can be thought of as a world wide language (WWL). The WWL, in an exemplary embodiment, is not intended to be written or spoken, but can be used to allow all people, communicating in a plurality of languages to obtain potentially any, and all, documents related to a given subject, assuming the UID lexicon database 114 is populated with all the languages of world and the document link/UID database 116 is populated with all documents related to a given term corresponding to a UID 230. The computer 138a can aggregate any subqueries according to symantic rules such as, e.g., boolean algebra, delimiter character 312 meanings, and other results narrowing tools including limitation features such as geographic region limitations 314, 318, 320, and 330. The computer 126 can then be provided a results list 308 from computer 138 and can cause this information to be provided to the client user 122 for review and selection, enabling selection and retrieval of documents corresponding to URLs 270a.

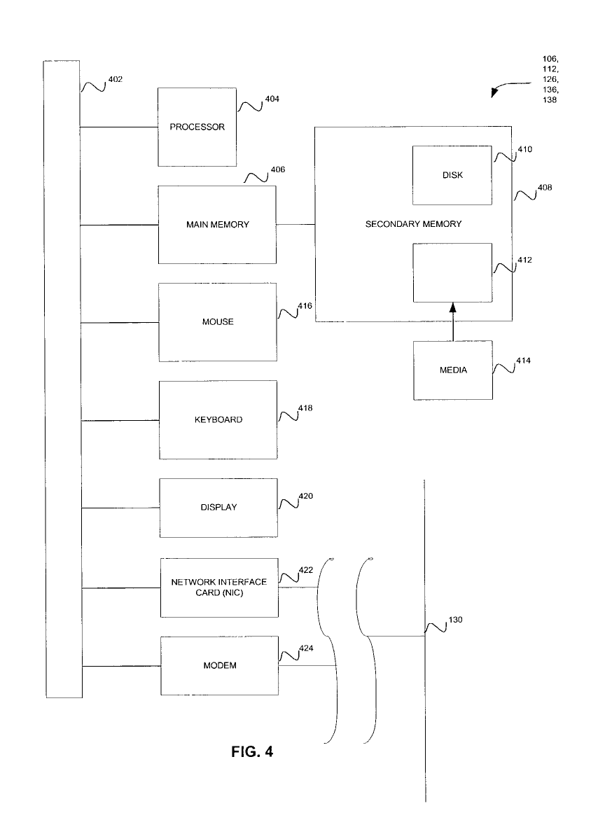

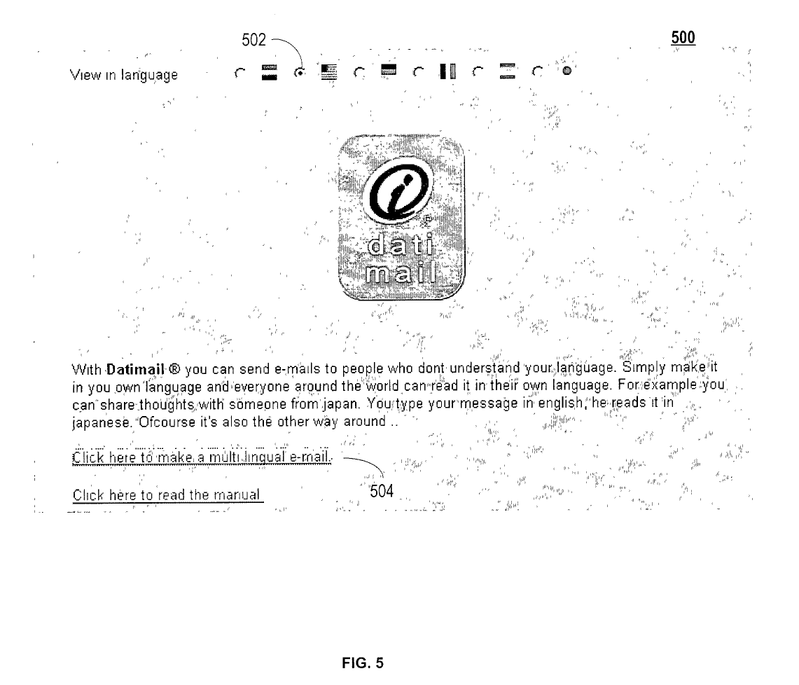

FIG. 5 depicts a screen capture 500 of an exemplary user interface by which a first client user 122 can send a multi-lingual email to a second client user 122. The first user is a “sender.” The second user is a “recipient.” The sender of an exemplary embodiment of a multi-lingual email can select a desired display language in which to generate the multilingual email from a group of selectable fields 502 indicative of the selected language. In the exemplary embodiment, selectable field 502 includes a national flag indicative of the selected language, i.e., a U.S. flag represents American English. Hyperlink 504 directs the sender to an interactive webpage and graphical user interface (as shown and described further below with reference to FIG. 6) wherein the sender generates the multilingual message for transmission to a recipient.

An exemplary embodiment of an interactive multi-lingual email generation application is depicted in FIG. 6. The application can include in an exemplary embodiment, a graphical user interface 600 which allows the sender of the multi-lingual email message to select a default “receiving language” of the recipient from a group of selectable fields 602 indicative of the selected language. The sender can then proceed to generate the multilingual message by selecting from a group of pre-translated terms contained in pull down menus 604, 606, 608, 610, 612, and 614. At the sender's option, an arbitrary non pre-translated term can be included in the message body by entering it in a “free field” 616. A term can include, e.g., a word, phrase, sentence, or grammatical term such as, e.g., a noun, verb, or adjective.

In the depicted exemplary embodiment, pull down menu 604 allows the sender to select from a group of pre-translated adjective/adverb terms each having a corresponding UID in UID database 114.

Pull down menu 606 can contain pre-translated article terms each with a corresponding UID.

Pull down menu 608 can contain pre-translated verb terms each having a corresponding UID.

Pull down menu 610 can contain pre-translated noun terms each having a corresponding UID.

Pull down menu 612 can contain pre-translated pronoun terms each having a corresponding UID.

Pull down menu 614 can contain pre-translated phrases, sentence fragments, or sentences each having a corresponding UID.

Arbitrary non-translated terms entered by the sender into free field 616 can possibly have no associated UID, can not be converted into a UID in one embodiment, and will be displayed as typed by the sender in the message body regardless of the selected language and will be similarly displayed in the original language when viewed by the multilingual message recipient in any selected language. Arbitrary non-translated terms can include without limitation: proper names, geographic locations, symbols, combinations of symbols, numbers, or letters, phrases, euphemisms, or any other word, phrase, or keystroke combination without a UID.

Once the sender selects a pre-translated term from available pull down menus or enters an arbitrary non-translated term or phrase in the free field 616, the sender clicks on the “add” command link 618, which places the arbitrary non-translated term or phrase into the message body.

In the exemplary illustration of FIG. 6 the sender has generated the following exemplary message for transmission:

“In reference to our telephone conversation Could you please send us a quotation for a Big Bicycle. We Will Go on Vacation Wednesday. Thanking you in advance, Merry Christmas and a happy New Year. Kind regards, Ralph”

Herein the article term “a” 626 is selected from pull down menu 606 and automatically added to the message body following selection. Accordingly, adjective term “Big” 624; selected from pull down menu 604, pronoun term “We” 632; selected from pull down menu 612, verb term “Go” 628; selected from pull down menu 608, noun term “Wednesday” 630; selected from pull down menu 610, and phrases “Kind regards” 634; selected from pull down menu 614, are sequentially added by the sender in generating the multilingual message to be transmitted. The proper name “Ralph” 636 is an arbitrary non-translated term entered into free field 616 and added to the message body by clicking the add command link 618.

If in generating the message body the sender makes an error or enters a term or phrase erroneously, the error can be corrected by clicking the backspace command link 620. If the sender desires to enter a line break in the same manner as a carriage return in a word processor, the line break can be inserted by clicking the line break command link 622.

Upon completion of the generated multilingual email message, the sender can dispatch the message to an intended recipient or group of recipients. The multilingual email message can include, in an exemplary embodiment, a series of pre-translated UIDs and/or non-translated terms stored in a database. The stored multi-lingual email message can be assigned a corresponding hyperlink 704 with embedded access IDs to allow a recipient to access the multi-lingual email.

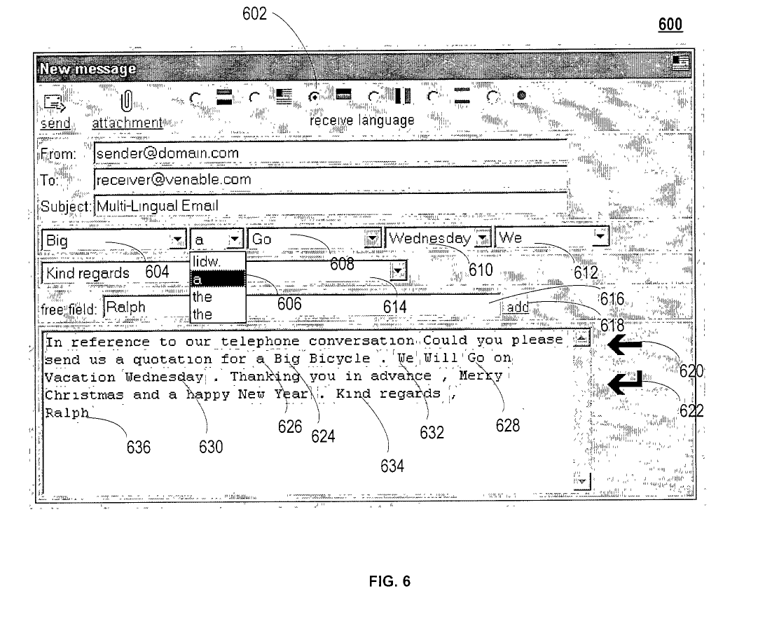

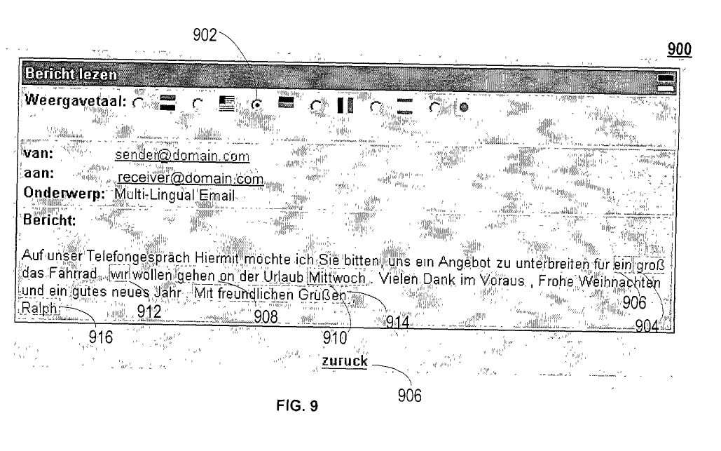

Upon transmission of the multilingual email message, a confirmation screen 700 can be displayed to the sender as depicted in the exemplary embodiment illustrated in FIG. 7, wherein the sender can be advised of the status of the sent message status 702. In an exemplary embodiment, the sender can be provided with the multi-lingual email message, a corresponding hyperlink 704 which retrieves the multi-lingual email message from the database for viewing (as shown in FIG. 9). In another exemplary embodiment, the sender can be given the option to return to the graphical user interface 600 (FIG. 6) to generate a new message by clicking the back command link 706.

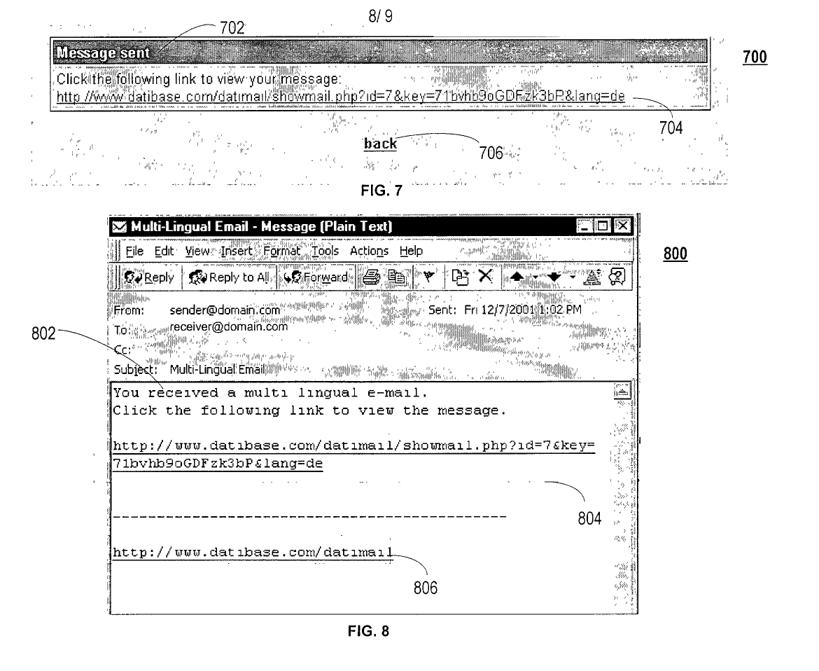

Turning now to FIG. 8, in an exemplary embodiment of the invention, the recipient of the multilingual email message can receive a message 802 via a standard mail client program advising the recipient that the recipient is in receipt of a multilingual email message. The message 802 in an exemplary embodiment can further provide the recipient with a hyperlink 804 from which to access the multi-lingual email. The recipient can also be provided with a hyperlink 806 to another link such as a multi-language email generator program, such as, e.g., www.Datimail.com (the Datimail homepage), available from datibase.com of Heerhugowaard, Netherlands.

Turning now to FIG. 9, the hyperlink 804 from FIG. 8 directs the multilingual email recipient to the screen 900 where the multilingual email message is displayed in the language selected 902 and, at the recipient's option, can be displayed in any one of the available selectable languages. The multilingual email message body is shown comprising terms generated by the sender displayed in the selected language, for example, in German. As shown in FIG. 6, each of the terms or phrases used to generate the multilingual email message have a specific UID pre-associated with various pre-translated terms in multiple languages. The terms are identified in the UID lexicon database and are displayed in a corresponding selected language 902. For example, in FIG. 6 the multilingual email message was originally generated by the sender in English but can be optionally viewed in any language selected 902. Here the German singular numeric article “ein” 906 of FIG. 9 has the same UID as the its equivalent English article “a” 626 (FIG. 6), the adjective “groβ” 904 has the same UID as English adjective “Big” 624, German pronoun “wir” 912 has the same UID as the English pronoun “We” 632, the German verb “gehen” 908 has the same UID as the English verb “Go” 628, and the German noun “Mittwoch” 910 has the same UID as the English noun “Wednesday” 630. In addition the invention compensates for the variations in expression and euphemism used by the world languages and generates language specific equivalents for expressions and phrases having the same UID. For example, the English phrase “Kind regards” 634 corresponds to the same UID as its German equivalent “Mit freundlichen Grüβen” 914. However, arbitrary and fanciful terms like “Ralph” 912, originally entered in the free field 616 in generating the multilingual email message, will appear as originally typed, having no UID and will not be flagged for translation by the message engine.

While viewing the multilingual email message display screen, the recipient can select to go “back” by selecting “zuruck” button 906 and can return to the previously selected language, or can return to the Datimail homepage 500 of FIG. 5.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents. While this invention has been particularly described and illustrated with reference to a preferred embodiment, it will be understood to those having ordinary skill in the art that changes in the above description or illustrations may be made with respect to formal detail without departing from the spirit and scope of the invention.

What is claimed is:

1. A method of generating a multilingual email message comprising:
(a) receiving a selection of an initial language in which to generate a multilingual email message;
(b) receiving a selection from a sender of one or more terms from a plurality of translated terms each associated with a corresponding unique identifier (UID); and
(c) storing said corresponding UIDs of said one or more terms into a file associated with said multilingual email message.

2. The method of claim 1, further comprising: (d) receiving input from the sender of one or more non translated terms without a corresponding UID; and (e) storing said nontranslated terms in said file associated with said multilingual email message.

3. The method of claim 1, further comprising: (d) receiving a send instruction from the sender; and (e) generating an email message comprising a link operative to allow viewing of said multilingual email message by a recipient.

4. The method of claim 3, further comprising: (f) receiving a selection of a display language from the recipient; and (g) providing the multilingual email message in said display language to the recipient for viewing.

5. The method of claim 1, wherein said plurality of translated terms are stored in a UID database and said UID database is used as a multilingual dictionary.

6. The method of claim 4, wherein at least one of said display language and said initial language is selected from the group consisting of Chinese, English, Spanish, French, German, Portuguese, Dutch, Japanese, Farsi, Turkish, Hebrew, Arabic, Greek, Swedish, Danish, Swahili, and Italian.

7. The method of claim 1, wherein said plurality of translated terms comprise at least one of: a word, a phrase, a plurality of words, an expression, a sentence, a grammatical term, a noun, a verb, an object, an article, a pronoun, an adjective, an adverb, a salutation, and a closing.

8. The method of claim 2, wherein said nontranslated terms comprise at least one of: a word, a phrase, a plurality of words, an expression, a sentence, a grammatical term, a noun, a verb, an object, an article, a pronoun, an adjective, an adverb, a salutation, and a closing.

9. A method of displaying a multilingual email message comprising:
(a) sending an email to a recipient comprising a link to a file associated with a multilingual email message, said file comprising a plurality of stored UIDs associated with one or more terms selected from a plurality of translated terms;
(b) receiving a selection of a display language in which to view said multilingual email message; and
(c) displaying said multilingual email message in said display language.

10. The method of claim 9, wherein said file further comprises one or more nontranslated terms.

11. The method of claim 9, wherein each of said plurality of stored UIDs correspond to a plurality of translated terms in a plurality of languages.

12. The method of claim 9, wherein said display language comprises at least one of Chinese, English, Spanish, French, German, Portuguese, Dutch, Japanese, Farsi, Turkish, Hebrew, Arabic, Greek, Swedish, Danish, Swahili, and Italian.

13. The method of claim 9, wherein said plurality of translated terms comprise at least one of a word, a phrase, a plurality of words, an expression, a sentence, a grammatical term, a noun, a verb, an object, an article, a pronoun, an adjective, an adverb, a salutation, and a closing.

14. The method of claim 10, wherein said nontranslated terms comprise at least one of a word, a phrase, a plurality of words, an expression, a sentence, a grammatical term, a noun, a verb, an object, an article, a pronoun, an adjective, an adverb, a salutation, and a closing.

15. A system for generating and storing a multilingual email message comprising:
means for receiving a selection of an initial language in which to generate a multilingual email message;
means for receiving a selection from a sender of one or more terms from a plurality of translated terms each associated with a corresponding UID; and
means for storing said corresponding UIDs of said one or more terms into a file associated with said multilingual email message.

16. The system of claim 15 further comprising:
means for receiving input from the sender of one or more nontranslated terms without a corresponding UID; and
means for storing said non translated terms in a file associated with said multilingual email message.

17. The system of claim 15, further comprising:
means for receiving a send instruction; and
means for receiving an email message comprising a link operative to allow viewing of said multilingual email message by a recipient.

18. The system of claim 17, further comprising:
means for receiving a selection of a display language from the recipients; and
means for providing the multilingual email message in said display language.

19. The system of claim 15, wherein said plurality of translated terms are stored in a UID database.

20. The system of claim 18, wherein at least one of said display language and said initial language is selected from the group consisting of Chinese, English, Spanish, French, German, Portuguese, Dutch, Japanese, Farsi, Turkish, Hebrew, Arabic, Greek, Swedish, Danish, Swahili, and Italian.

21. The system of claim 15, wherein said plurality of translated terms comprise at least one of: a word, a phrase, a plurality of words, an expression, a sentence, a grammatical term, a noun, a verb, an object, an article, a pronoun, an adjective, an adverb, a salutation, and a closing.

22. The system of claim 16, wherein said nontranslated terms comprise at least one of: a word, a phrase, a plurality of words, an expression, a sentence, a grammatical term, a noun, a verb, an object, an article, a pronoun, an adjective, an adverb, a salutation, and a closing.

23. A system for displaying a multilingual email message comprising:
means for sending an email comprising a link to a file associated with a multilingual email message comprising a plurality of stored UIDs associated with one or more terms selected from a plurality of translated terms,
means for selecting a display language in which to view said multilingual email message, and
means for displaying said multilingual email message in the selected display language.

24. The computer system of claim 23, wherein said file further comprises nontranslated terms.

25. The computer system of claim 23, wherein each of said plurality of stored UIDs correspond to a plurality of translated terms in a plurality of languages.

26. The computer system of claim 23, wherein said display language comprises at least one of Chinese, English, Spanish, French, German, Portuguese, Dutch, Japanese, Farsi, Turkish, Hebrew, Arabic, Greek, Swedish, Danish, Swahili, and Italian.

27. The computer system of claim 23, wherein said plurality of translated terms comprise at least one of a word, a phrase, a plurality of words, an expression, a sentence, a grammatical term, a noun, a verb, an object, an article, a pronoun, an adjective, an adverb, a salutation, and a closing.

28. The computer system of claim 24, wherein said nontranslated terms comprise at least one of a word, a phrase, a plurality of words, an expression, a sentence, a grammatical term, a noun, a verb, an object, an article, a pronoun, an adjective, an adverb, a salutation, and a closing.

29. A computer program product embodied on a computer readable medium including program logic, the program logic operative to enable a computer to generate a multilingual email message comprising:
first selection program logic operative to enable the computer to select an initial language in which to generate a multilingual email message;
second selection program logic operative to enable the computer to select one or more terms from a plurality of translated terms each associated with a corresponding UID;
program logic operative to enable the computer to generate a multilingual email message with said translated terms in the message body; and
program logic operative to enable the computer to store the corresponding UIDs of the one or more translated terms into a file associated with said multilingual email message.

30. The computer program product of claim 29 further comprising program logic operative to enable a computer to input of one or more non translated terms without a corresponding UID and program logic operative to enable a computer to store said non translated terms in said file associated with said multilingual email message.
